(19) United States
(12) Patent Application Publication
(10) Pub. No.: US 2004/0163492 A1
(43) Pub. Date: Aug. 26, 2004

(54) Method for producing foamed aluminum products

(76) Inventors: Mark D. Crowley, Pittsburgh, PA (US); J. Daniel Bryant, Murrysville, PA (US); David D. Leon, Murrysville, PA (US); Jacob A. Kallivayalil, Pittsburgh, PA (US); Joseph R. Genito, Lower Burrell, PA (US); Patricia A. Stewart, Pittsburgh, PA (US); Dorothy M. Schrall, Natrona Heights, PA (US); Larry F. Wieserman, Apollo, PA (US); Larry B. Davis, Richmond, VA (US)

Correspondence Address: ECKERT SEAMANS CHERIN & MELLOTT, LLC, ALCOA TECHNICAL CENTER, 100 TECHNICAL DRIVE, ALCOA CENTER, PA, 15069-0001, US

(21) Appl. No.: 10/792,501

(22) Filed: Mar. 2, 2004

Related U.S. Application Data
(63) Continuation-in-part of application No. 10/150,338, filed on May 16, 2002.
(60) Provisional application No. 60/291,753, filed on May 17, 2001.

(51) Int. Cl. B05D 7/00

(52) U.S. Cl. 75/415; 427/212; 428/613; 428/403; 164/97; 428/570

(57) ABSTRACT

The present invention is directed to porous metal products including ceramic particles, where the initial surface layer (12) of the particles (10) is modified with agents that interact with surface oxygen, oxides and/or hydroxides to improve the wettability of particles within a molten metal alloy, and where the ceramic particles (10) are modified (14) by contacting the particles with a surface-modifying agent and heating the ceramic particles and surface-modifying agent to an elevated temperature at which the ceramic particle remains substantially stable and the surface-modifying agent becomes at least partially thermally unstable, to cause a reacted layer (16).

### CROSS REFERENCE TO RELATED APPLICATIONS

This application is a continuation in-part application of U.S. application Ser. No. 10/150,338 filed May 16, 2002 which claims the benefit of U.S. Provisional Patent Application No. 60/291,753 filed May 17, 2001.

### FIELD OF THE INVENTION

The present invention is directed to a method of making porous metal products having ceramic particles dispersed therein, and more particularly relates to a method of modifying the surface of ceramic particles with agents that reduce or eliminate surface oxides to allow for improved distribution in a molten alloy.

### BACKGROUND INFORMATION

Low-density porous products offer unique mechanical and physical properties. The high specific strength, structural rigidity and insulating properties of foamed products produced in a polymer matrix are well known. Such closed cell polymeric foams are used extensively in a wide range of applications, including construction, packaging and transportation.

While polymeric foams have enjoyed wide market success, foamed metal products have seen only limited applications. Closed cell metallic foams offer many of the attractive attributes of polymeric foam in respect to mechanical and thermal properties. In addition, the inherently higher bulk modulus of metals, as compared to polymers, provides higher specific rigidity. This higher modulus makes metal foams attractive candidates as core materials in laminate panels, where rigidity and resistance to deflection are important performance measures. In addition, foamed metal panels are fire and smoke resistant making them useful for construction applications. Aluminum foam cored sandwich products offer the additional environmental benefit of being recyclable; an issue that has restricted the use of clad polymer foams.

While methods of producing foamed metals have been described in the scientific and patent literature, such materials suffer from problems such as high cost and insufficient structural integrity. For example, attempts at reducing manufacturing costs have not been successful due to poor product integrity and high unit costs. Practices have been developed wherein gas-producing agents are added directly to an aluminum melt, or wherein gas is injected into the melt directly. In both cases, the melts must be vigorously agitated to develop a fine distribution of gas bubbles in the liquid metal mass. The melt is then either slowly cooled to retain the foamed mass in the mixing crucible, or the froth is extracted from the top of the agitated bulk melt and slowly cooled.

In substantially all casting metallurgy methods of producing metallic foams, some stabilization is required in the metallic melt. A substantial increase in the viscosity of the liquid metal is required to sustain the appropriate rheology to create a stable foam mass due to the relatively slow cooling of the liquid foam into a solid mass.

Foams are meta-stable and therefore prone to both coalescence and decay. To delay such decay, high levels of stabilization are required. To achieve stabilization, ceramic particles are added to the melt. Ceramic particles may be added by formulating the alloy melt to induce precipitation of large, intermetallic particles. Typically, high levels of calcium are included in the melt to precipitate calcium aluminides and aluminum-calcium spinels into the melt that act to increase the melt viscosity. In other methods, the aluminum melt is vigorously agitated in air, encouraging the formation of metallic oxides in the melt that act to increase the melt viscosity. While cost effective, this method requires a precursor melt with a very high viscosity, owing to the slow cooling rates employed. In practice this equates to high dross content that, while foamable, produces a final product that is very brittle and has poor general integrity. Additionally, the extended periods of agitation required to produce such a viscous precursor melt increase production costs.

Ceramic particles may also be added to the melt directly where needed to promote a melt viscosity that allows for stable liquid foam to be formed. This method has the advantage of allowing for the selection of ceramic particles that do not diminish the integrity of the foamed product. However, the melt must be stirred vigorously for extensive periods of time to homogenously distribute the ceramic particles throughout the melt. The precursor composite melt must then be subsequently foamed after the particles have been sufficiently wetted by the alloy melt.

Traditional methods of introducing ceramic particles into foamed metals require extensive and aggressive stirring that is technically challenging and economically unattractive. The long mixing times required to disperse the particles results in unwanted reactions between the particles and the molten metal. Similar problems exist for the introduction of non-oxide particles. For example, while SiC can be wetted by liquid aluminum, the melt must be agitated at temperatures over 1,400° F. for many hours to achieve effective wetting.

High quality metal-foams require a relatively homogenous distribution of ceramic particles within the metal matrix. Homogenous distribution is typically achieved by mixing or vigorously agitating the melt to evenly distribute the ceramic particles in the molten aluminum alloy. However, the time required for even marginal mixing of the melt is often much longer than the duration of time required to establish appropriate mixing conditions. Agitating the molten body can entrain oxygen in the melt, which can result in the formation of unwanted oxides. While the oxides can act to increase the viscosity of the melt, the mechanical properties of the resulting product are generally diminished, resulting in a brittle and weak matrix. To limit oxidation, agitation has often been imposed under conditions of inert atmosphere or vacuum, adding significantly to the expense without decreasing the required agitation time.

During the production of aluminum foams, ceramic particles added to the melt may decompose with heating, producing decomposition products in the form of gases that form small uniform bubbles or pores in the molten alloy. Copending U.S. patent application Ser. No. 10/150,338, the entire disclosure of which is herein incorporated by reference, describes a method of making foamed aluminum and a process through which bubble or pore size can be controlled by the customization of the composition and particle size distribution of the ceramic particles.

The present invention has been developed in view of the foregoing.

### SUMMARY OF THE INVENTION

The present invention provides a method of making surface-modified ceramic particles that may be used in the formation of low-density porous products, such as foamed metal and foamed metal products. The surfaces of the ceramic particles are contacted with a surface modifying agent and heated to an elevated temperature at which the surface-modifying agent reacts with the surface of the ceramic particles, providing for improved wettability and increased distribution within a molten alloy. The resulting surface-modified ceramic particles are easily wettable by molten metals such as aluminum. In one embodiment, the ceramic particles and the surface-modifying agent are heated to an elevated temperature wherein the ceramic particle remains substantially a solid and the surface-modifying agent is thermally unstable such that the surface-modifying agent chemically reacts with the surface of the ceramic particles to form a dispersion-enhancing surface layer and reduces the surface oxide layers that form thereon.

The foamed metal products made by the process of this invention exhibit improved properties such as low density and high rigidity, decreased thermal conductivity, and improved tensile strength, impact resistance, yield strength and sound deadening properties. The foamed metal products may be used in various applications such as high performance lightweight automotive technology, thin sheet materials, architectural construction materials, buoyant applications, and any field where effective utilization of energy for motion is required.

An aspect of the present invention is to provide a method of making a porous metal product comprising the steps of providing ceramic particles having a dispersion-enhancing surface layer, combining the ceramic particles with molten metal and forming a foamed metal-ceramic melt in which the ceramic particles are wetted by the molten metal, and solidifying the metal-ceramic melt to form a porous metal product.

Another aspect of the present invention is to provide a method of making ceramic particles having a dispersion-enhancing surface layer, the method comprising the steps of providing ceramic particles having an initial surface layer having at least some oxygen, oxide and/or hydroxide, contacting the initial surface layer of the ceramic particles with a surface-modifying agent, and heating the ceramic particles and the surface-modifying agent to an elevated temperature to form a dispersion-enhancing surface layer on the ceramic particles.

Another aspect of the present invention is to provide ceramic particles for use in the manufacture of porous metal products comprising a ceramic core, and a dispersion-enhancing surface layer comprising a chemical reaction product of at least one fluorine, chlorine, boron or phosphate compound with an initial surface layer of the ceramic core.

Yet another aspect of the present invention is to provide a porous metal product comprising a porous metal matrix comprising a discontinuous distribution of closed pores, and a distribution of ceramic particles having a dispersion-enhancing surface layer comprising at least one fluorine, chlorine, boron or phosphate compound dispersed within the metal matrix.

These and other aspects and advantages of the present invention will occur to persons skilled in the art from the following detailed description.

### BRIEF DESCRIPTION OF THE DRAWINGS

FIG. 1A is a schematic diagram showing the before and after modification of the hydroxylated surface layer of a ceramic gassing particle or a ceramic viscosity-modifying particle, and FIG. 1B is a schematic diagram showing a magnified view of the surface before and after surface modification.

FIG. 2 is a graph of the weight % change over time vs ° C. of the stable temperature range (solid line) for magnesium carbonate.

FIG. 3 is a graph of the the weight % change over time vs ° C. of the stable temperature range (solid line) for a boehmite/todhite mixture.

FIG. 4 is a graph of the weight % change over time vs ° C. of the stable temperature range (solid line) for calcium carbonate.

FIG. 5 is a graph of the weight percent change vs ° C. over time for ammonium bifluoride.

FIG. 6 is a graph of the weight percent change vs ° C. over time for magnesium hexafluorosilicate.

FIG. 7 is a graph of the weight percent change vs ° C. over time for sodium hydrogen fluoride.

### DETAILED DESCRIPTION OF PREFERRED EMBODIMENTS

Molten metals, such as aluminum alloys, do not readily wet ceramic particles. When ceramic particles are introduced into an aluminum matrix, the ceramic particles tend to agglomerate and do not uniformly disperse within the metal matrix. For example, when ceramic gassing agents are added to a molten metal, they typically stick together and do not readily disperse within the molten metal matrix. When large agglomerates of ceramic gassing agents decompose upon heating, excessively large bubbles can rise to the surface of the molten alloy and be lost into the atmosphere, resulting in lost material from the molten melt and exposure of personnel to potentially harmful operating conditions. Large agglomerates of ceramic gassing agents also typically exhibit poor wettability. This tends to result in fewer bubble nucleation centers for gas production within the molten metal than particles that are easily wetted. Furthermore, when ceramic viscosity enhancing agents are added to a molten metal, they also tend to agglomerate and do not readily disperse within the metal matrix. When ceramic viscosity enhancing agents form large agglomerates within the molten metal, the effectiveness of the viscosity enhancing agents is greatly reduced.

The present invention provides for a method of homogenously distributing ceramic particles in a molten metal or alloy by modifying the surface of the ceramic particles to displace or reduce at least a part of the surface oxygen, oxide and/or hydroxide layer that forms thereon when the ceramic particles are contacted by a molten metal or alloy.

As used herein, the term “ceramic particles” means any inorganic non-metallic particle capable of producing gas at the temperature of the molten alloy or effective to enhance the viscosity of the molten metal. Ceramic particles can include compounds comprising alkali metals, alkaline earth metals, transition metals, Al, Si, Ga, Ge, In, Sn, and Bi.

In one embodiment, the ceramic particles may be used as gassing agents. Example inorganic non-metallic particles that can be used as ceramic gassing agents, to release gas when combined with a molten metal or alloy at elevated temperatures, include inorganic carbonates, hydrides, fluorides, sulfates, nitrates, nitrites, hydroxides and combinations thereof.

In another embodiment, the ceramic particles can be used as viscosity enhancing agents, to enhance the viscosity of a molten metal or alloy. Example inorganic non-metallic particles that can be used as ceramic viscosity enhancing agents, include combinations of metal and oxides, hydroxides, nitrides, borides, chlorides, carbides, sulfides, sulfites, phosphates and combinations thereof.

Examples of suitable carbonates for use as the ceramic particle gassing agents include magnesium carbonate, calcium carbonate, lithium carbonate, potassium carbonate, sodium carbonate, sodium bicarbonate, strontium carbonate, rubidium carbonate, barium carbonate and combinations thereof.

Examples of suitable hydrides for use as the ceramic particle gassing agents include titanium dihydride, sodium hydride, potassium hydride, lithium hydride and combinations thereof.

Examples of suitable fluorides for use as the ceramic particle gassing agents include aluminum fluoride, ammonium bifluoride, ammonium fluoride, ammonium fluoroborate, ammonium fluorophosphate, ammonium hexafluorosilicate, ammonium zirconium fluoride, calcium fluoride, calcium fluoroborate (anhyd), iron (III) fluoride, iron (III) fluoride trihydrate, magnesium fluoride, magnesium hexafluorosilicate, pentafluoroproponic acid, potassium hexafluoroaluminate, potassium hexafluorosilicate, potassium zirconium fluoride, sodium fluoride, sodium hexafluoroaluminate, sodium hexafluorosilicate, sodium hydrogen fluoride, sodium tetraborate, sodium tetrafluoroborate, tin (II) fluoride, zirconium (IV) fluoride and combinations thereof.

Examples of suitable hydroxides for use as the ceramic particle gassing agents include aluminum trihyroxide, aluminum oxyhydroxide, magnesium hydroxide, calcium hydroxide, barium hydroxide and combinations thereof.

Examples of suitable sulfates and sulfites for use as the ceramic particle gassing agents include aluminum sulfate, barium sulfate, barium sulfite, bismuth sulfate, cadmium sulfate, calcium sulfate, calcium sulfite, cerium sulfate, cesium sulfate, copper sulfate, gandolinium sulfate, gallium sulfate, hafnium sulfate, indium sulfate, iron sulfate, lead sulfate, lead sulfite, lithum sulfate, magnesium sulfate, manganese sulfate, neodymium sulfate, nickel sulfate, potassium sulfate, potassium sulfite, rhodium sulfate, rubidium sulfate, sodium sulfate, sodium sulfite, strontium sulfate, thallium sulfate, vanadium sulfate, zinc sulfate, zinc sulfite, zirconium sulfate hydroxide and combinations thereof.

Examples of suitable nitrates and nitrites for use as the ceramic particle gassing agents include aluminum nitrate, barium nitrate, barium nitrite, bismuth nitrate, cadmium nitrate, calcium nitrate, calcium nitrite, cesium nitrate, chromium nitrate, cobalt nitrate, copper nitrate, iron nitrate, lead nitrate, lithium nitrate, magnesium nitrate, magnesium nitrate, manganese nitrate, mercury nitrate, potassium nitrate, potassium nitrite, silver nitrate, silver nitrite, sodium nitrate, sodium nitrite, strontium nitrate, strontium nitrite, zinc nitrate, zinc nitrite and combination thereof.

Examples of suitable oxides for use as the ceramic viscosity enhancing agents include aluminum oxide, silicon dioxide, beryllium oxide, magnesium oxide, calcium oxide, barium oxide, titanium oxide, vanadium oxide, chromium oxide, manganese oxide, iron oxide, cobalt oxide, nickel oxide, copper oxide, zinc oxide, zirconium oxide, silver oxide, tin oxide, tantalum oxide, tungsten oxide, rhenium oxide and combinations thereof.

Examples of suitable nitrides for use as the ceramic viscosity enhancing agents include boron nitride, copper nitride, barium nitride, silicon nitride, silver nitride, titanium nitride, zirconium nitride, vanadium nitride, tantalum nitride, chromium nitride, molybdenum nitride, tungsten nitride, cobalt nitride, nickel nitride, magnesium nitride, aluminum nitride and combinations thereof.

Examples of suitable borides for use as the ceramic viscosity enhancing agents include titanium boride, zirconium boride, hafnium boride, niobium boride, tantalum boride, chromium boride, molybdenum boride, tungsten borides and combinations thereof.

Examples of suitable chlorides for use as the ceramic viscosity enhancing agents include silver chloride, aluminum chloride, barium chloride, beryllium chloride, bismuth chloride, calcium chloride, cadmium chloride, cerium chloride, cobalt chloride, chromium chloride, copper chloride, iron chloride, gallium chloride, germanium chloride, potassium chloride, sodium chloride, lanthanum chloride, lithium chloride, magnesium chloride, manganese chloride, molybdenum chloride, potassium chloride, nickel chloride, rubidium chloride, tin chloride, antimony chloride, scandium chloride, strontium chloride, tantalum chloride, titanium chloride, zinc chloride, zirconium chloride and combinations thereof.

Examples of suitable carbides for use as the ceramic viscosity enhancing agents include silicon carbide, tungsten carbide, titanium carbide, chromium carbide, tantalum carbide, chromium carbide, molybdenum carbide, tungsten carbides and combinations thereof.

Examples of suitable sulfides for use as the ceramic viscosity enhancing agents include silicon sulfides, germanium sulfides, tin sulfides, boron sulfides, aluminum sulfides, gallium sulfides, indium sulfides, barium sulfides, vanadium sulfides, niobium sulfides, tantalum sulfides, chromium sulfides, molybdenum sulfides, tungsten sulfides, manganese sulfides, iron sulfides, cobalt sulfides, copper sulfides, silver sulfides, gold sulfides, zinc sulfides, cadmium sulfides, cesium sulfides and combinations thereof.

Examples of suitable sulfates for use as the ceramic viscosity enhancing agents include aluminum sulfates, barium sulfates, calcium sulfates, cadmium sulfates, cerium sulfates, cobalt sulfates, cesium sulfates, copper sulfates, iron sulfates, indium sulfates, potassium sulfates, lanthanum sulfates, lithium sulfates, magnesium sulfates, manganese sulfates, molybdenum sulfates, sodium sulfates, nickel sulfates, rubidium sulfates, strontium sulfates, zinc sulfates, zirconium sulfates and combinations thereof.

Examples of suitable phosphates for use as the ceramic viscosity enhancing agents include lithium orthophosphates, sodium orthophosphate, potassium orthophosphates, magnesium phosphates, calcium phosphates, strontium phosphates, barium phosphates, boron phosphates, aluminum phosphates, iron phosphates and combinations thereof.

Some particularly suitable ceramic viscosity enhancing particles include Al₂O₃, CaCO₃, MgO, SiC, BN, and magnesium silicates (MgSiO₃, Mg₂SiO₄, Mg₂Si₃O₈, Mg₂Si₂O₇). Metallurgical grade Al₂O₃ may be particularly preferred due to its availability and compatibility with standard recycling techniques.

The ceramic particles may have any desired morphology, such as equiaxed, fibers, rods, plates and the like. In one embodiment, the ceramic particles have an average size of from about 10 nm to about 3 mm. In another embodiment, the ceramic particles have an average size of from about 0.01 micron to about 1 mm.

When the ceramic particles are added to the melt for the purpose of producing gas, the ceramic particles can be selected to have good stability at low temperatures and decompose producing gas at temperatures near or above the melting point of the metal alloy. The size of the ceramic particles intended to be introduced into the molten metal or alloy can be selected based on the desired foamed metal pore size. In metallurgical casting methods of producing foamed aluminum, ceramic particles may decompose with heating and form small uniform bubbles in the molten alloy melt. The size and composition of the ceramic particles introduced into the melt determines the size of the bubble produced as a result of the decomposition of the ceramic particle in an aluminum alloy. For example, boehmite (AlOOH) yields one mole of water for every two moles of boehmite thermally decomposed [2AlOOH→Al₂O₃+H₂O]. Using the gas law equation of PV=nRT where P is pressure, V is volume, n is the number of moles, R is the universal gas constant, and T is temperature, a calculation can be made to determine the particle size of boehmite required to produce one gas bubble with a specific volume or diameter. In comparison, when gibbsite Al(OH)₃) is used as the gassing agent, three moles of water are produced for every two moles of gibbsite [2Al(OH)₃→Al₂O₃+3H₂O]. Thus the total pore volume produced using the same number of moles of gibbsite is three times greater than the total pore volume produced using boehmite.

By altering the size of the bubble produced in a foamed aluminum mass, thermal resistance and yield strength can be improved. For cosmetic reasons, the bubble size may be selected such that the resulting pores or bubbles will not effectively scatter visible light and the foamed aluminum will not appear to be visibly distinct from solid aluminum in the absence of increased magnification.

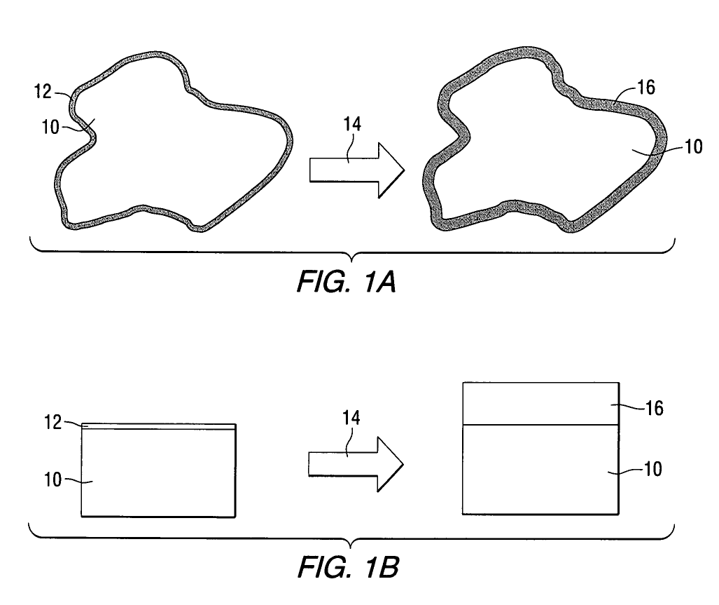

According to the method of the present invention, as schematically shown in FIGS. 1A and 1B, the initial surface layer 12 of the ceramic particles 10, having a central core, is contacted with a surface-modifying agent, as indicated by the arrow 14, to modify the surface of the ceramic particles by reducing or displacing at least a portion of the surface oxygen, oxide and/or hydroxide layer that is present on the ceramic particles to cause a reacted layer 16 which causes the ceramic particles to easily disperse when the ceramic particles are added to the melt. FIG. 1B shows an idealized magnified view of layers 12 and 16, where, for example, a metal oxide/hydroxide carbonate particle 10, with hydroxylated layer 12, is reacted/contacted with a surface modifying agent to form reacted fluoro, boro, phospho and/or chloro layer 16. In one embodiment, the initial surface layer can comprise impurities, such as oxygen. In another embodiment, the initial surface layer can comprise the same material as the core material of the ceramic particle, such as oxide or hydroxide ceramic particles.

As used herein, the term “surface-modifying agent” includes fluorine, chlorine, boron and/or phosphate containing compounds and combinations thereof that are capable of forming a compound with the initial surface of ceramic particles. The surface-modifying agents initiate a chemical reaction with the initial surface of the ceramic particles.

Examples of suitable fluoride compounds that can be used as surface-modifying agents include aluminum fluoride, ammonium bifluoride, ammonium fluoride, ammonium fluoroborate, ammonium fluorophosphate, ammonium hexafluorosilicate, ammonium zirconium fluoride, calcium fluoride, calcium fluoroborate, fluorinated graphite such as Carbofluor Rx , iron (III) fluoride, iron (III) fluoride trihydrate, hydrofluoric acid, magnesium fluoride, magnesium hexafluorosilicate, potassium fluoroaluminate, potassium hexafluorosilicate, potassium zirconium fluoride, sodium fluoride, sodium fluoroaluminate, sodium hexafluorosilicate, sodium hydrogen fluoride, sodium tetraborate, sodium tetrafluoroborate, PTFE, tin (II) fluoride, zirconium (IV) fluoride, zinc fluoride and combinations thereof. Anhydrous and hydrous forms are included as sutitable fluroride compounds that can be used as surface modifying agents.

Examples of suitable chloride compounds that can be used as surface-modifying agents include actinium chloride, antimony chloride, aluminum chloride, ammonium chloride, ammonium zirconium chloride, barium chloride, boron trifluoride, bismuth chloride, chlorine gas, calcium chloride, carbonyl chloride, hydrochloric acid, iron (III) chloride, lithium chloride, magnesium chloride, manganese chloride, nickel chloride, potassium chloride, potassium zirconium chloride, sodium chloride, sodium hydrogen chloride, tin (II) chloride, zirconium (IV) chloride, zinc chloride and combinations thereof.

Examples of suitable boron compounds that can be used as surface-modifying agents include ammonium pentaborate, potassium pentaborate, sodium tetraborate, boric acid and combinations thereof.

Examples of suitable phosphate compounds that can be used as surface-modifying agents include phosphoric acid, ammonium phosphate, phosphorus acid, pyrophosphoric acid and combinations thereof.

As used herein, the term “contacted with a surface-modifying agent” means that a surface-modifying agent, such as any individual compound or combination of compounds listed above, is intentionally introduced to the initial surface layer of the ceramic particles, that is, the surface-modifying agent and the ceramic particles are mixed together. In one embodiment, the surface-modifying agent is substantially solid. In another embodiment, the surface-modifying agent is substantially liquid. In another embodiment, the surface-modifying agent is substantially a gas. Once the ceramic particles and surface-modifying agent have been combined, the combined mixture is heated to an elevated temperature, such that the surface-modifying agent modifies the initial surface layer of the ceramic particles by forming a dispersion-enhancing surface layer. As used herein, the term “modifies the surface of the ceramic particles” means that the surface-modifying agent chemically modifies the initial surface layer of the ceramic particles thereby altering the chemistry of the ceramic particle by displacing or reducing at least a part of the oxygen, oxide and/or hydroxide present in the initial surface layer. As used herein, the term “dispersion-enhancing surface layer” means the initial surface layer of the ceramic particle has been modified by a chemical reaction product of at least one fluorine, chlorine, boron and/or phosphate compound wherein at least a portion of the oxygen, oxide and/or hydroxide from the initial surface layer has been removed. The resulting dispersion-enhancing surface modified ceramic particles allow for a more homogenous mixing at the time when the ceramic particles are introduced into the molten metal matrix.

As used herein, the term “elevated temperature” means a temperature at which the ceramic particle remains substantially solid and at which the surface-modifying agent is at least partially thermally unstable. The elevated temperature is typically at least about 50° C., for example from about 50° C. to about 500° C. In one embodiment, the elevated temperature is about 100° C. In another embodiment, the elevated temperature is about 125° C. In yet another embodiment, the elevated temperature is about 180° C. As used herein, the term “thermally unstable” means that the surface-modifying agent is capable of undergoing a phase change or is capable of initiating a chemical reaction when subjected to an increased temperature. In one embodiment, the surface-modifying agent becomes at least partially liquid, thereby chemically bonding with the surface of the ceramic particles. In another embodiment, the surface-modifying agent becomes at least partially becomes a gaseous.

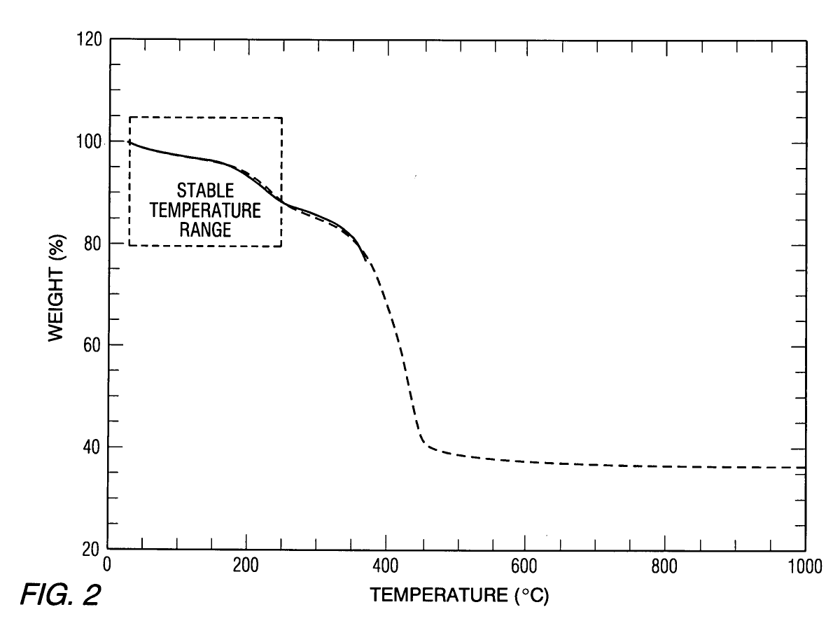

Different ceramic particle materials have different temperature stability ranges. In one embodiment of the present invention, magnesium carbonate ceramic particles, as shown in FIG. 2, have a stable temperature range of up to about 250° C. (482° F.). This means that methods of modifying the surface of the ceramic particles employing temperatures below about 250° C. (482° F.) can be used to successfully modify the surface of the magnesium carbonate particles without causing premature decomposition of the magnesium carbonate particles. At temperatures above about 250° C. (482° F.) the magnesium carbonate particles are thermally unstable and may undergo a premature thermal decomposition to form magnesium oxide.

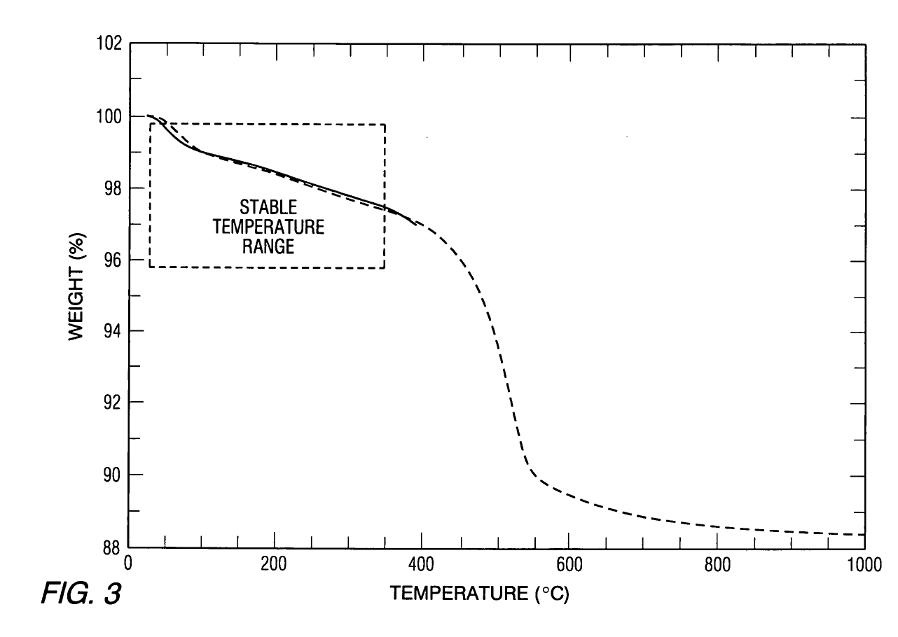

In another embodiment of the present invention, boehmite/todhite mixture ceramic particles, as shown in FIG. 3, have a stable temperature range of up to about 350° C. (662° F.). This means that methods of modifying the surface of the ceramic particles employing temperatures below about 350° C. (662° F.) can be used to successfully modify the surface of the ceramic particles without causing premature decomposition of the boehmite/todhite mixture particles. At temperatures above about 350° C. (662° F.) the boehmite/todhite particles are thermally unstable and may undergo a premature thermal decomposition to form aluminum oxide.

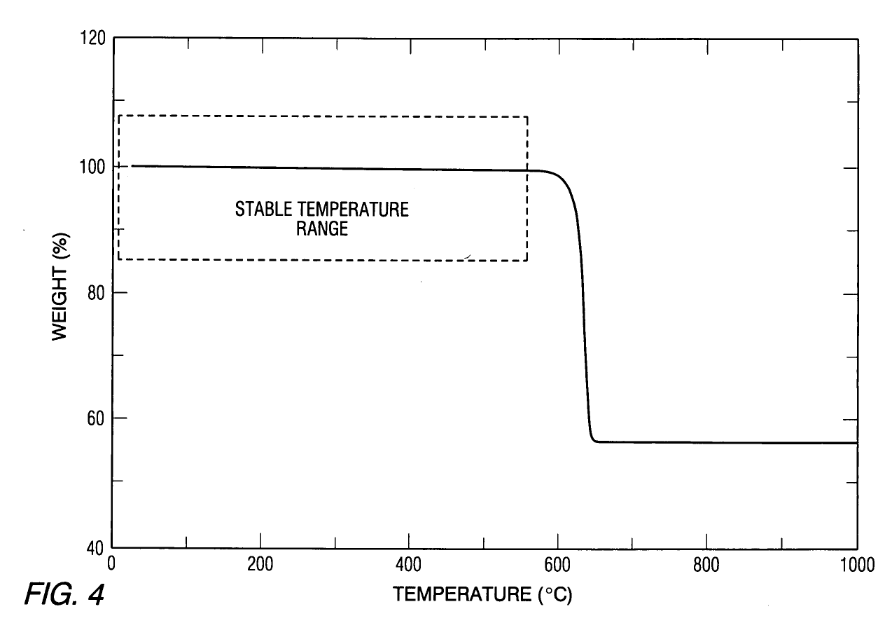

In yet another embodiment of the present invention, calcium carbonate ceramic particles, as shown in FIG. 4, have a stable temperature range of up to about 550° C. (1,022° F.). This means that methods of modifying the surface of the ceramic particles employing temperatures below about 550° C. (1,022° F.) can be used to successfully modify the surface of the ceramic particles without causing premature decomposition of the calcium carbonate particles. At temperatures above about 550° C. (1,022° F.) the calcium carbonate particles are thermally unstable and may undergo a premature thermal decomposition to form calcium oxide.

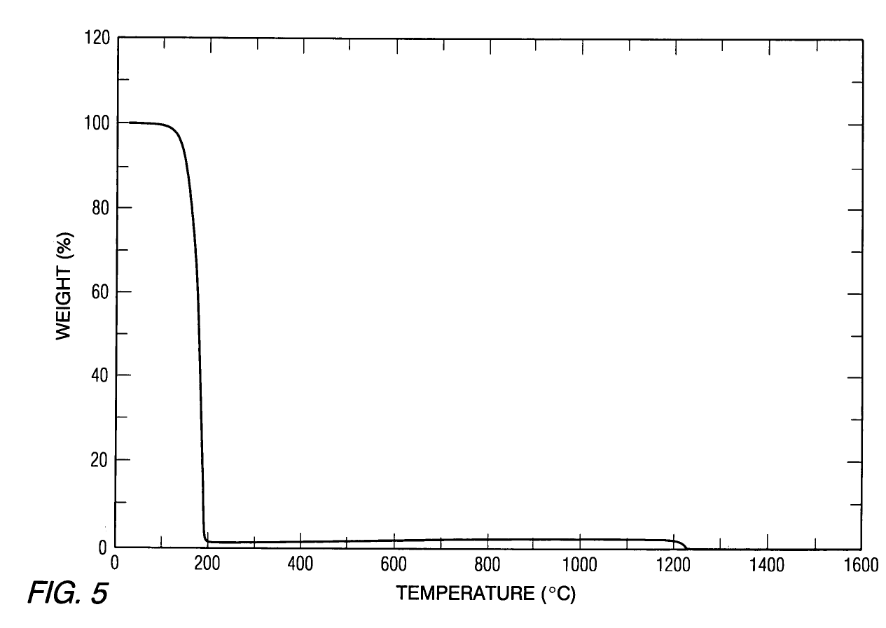

Different surface-modifying agents also have different temperature stability ranges. In one embodiment of the present invention, an ammonium bifluoride surface-modifying agent has a stable temperature range of up to about 100° C. (212° F.). As shown in FIG. 5, a 6.52 mg sample of ammonium bifluoride was heated to a temperature of about 1,225° C. (2,237° F.). FIG. 5 shows that when ammonium bifluoride contacts the surface of ceramic particles and the temperature is elevated above about 100° C. (212° F.) the ammonium bifluoride surface-modifying agent is thermally unstable and can chemically react with the surfaces of ceramic particles. The preferred treatement temperature is above 250° C. (482° F.).

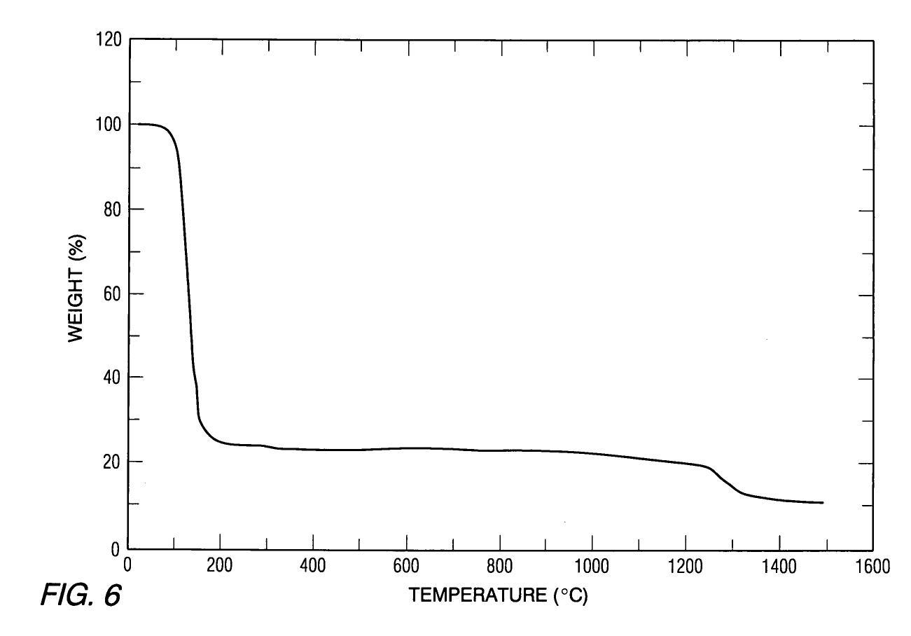

In another embodiment of the present invention, a magnesium hexafluorosilicate surface-modifying agent has a stable temperature range of up to about 100° C. (212° F.). As shown in FIG. 6, a 7.19 mg sample of magnesium hexafluorosilicate was heated to a temperature of about 1,500° C. (2,732° F.). FIG. 6 shows that when magnesium hexafluorosilicate contacts the surface of ceramic particles and the temperature is elevated above about 100° C. (212° F.) the magnesium hexafluorosilicate surface-modifying agent is thermally unstable and can chemically react with the surfaces of ceramic particles. The preferred treatement temperature is above 250° C. (482° F.).

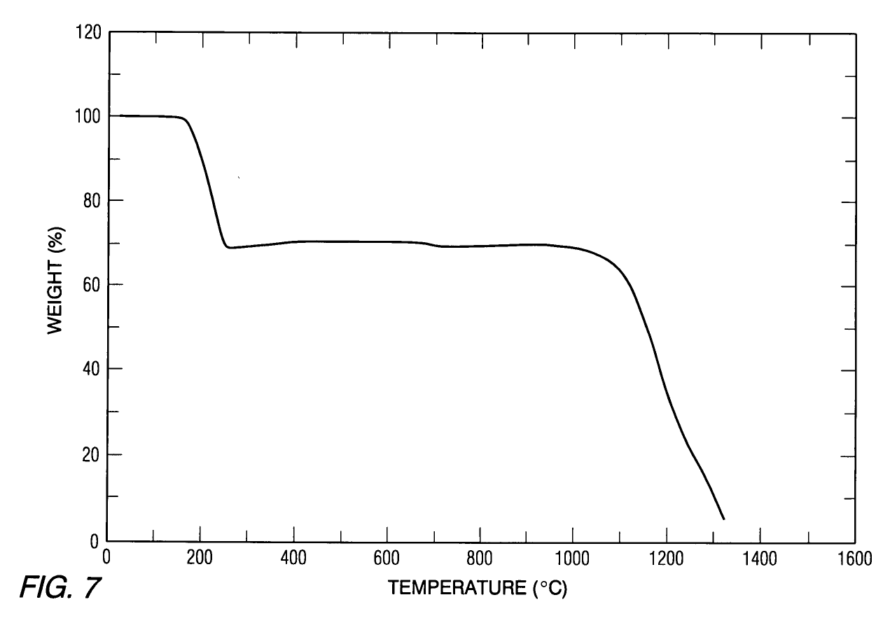

In yet another embodiment of the present invention, a sodium hydrogen fluoride surface-modifying agent has a stable temperature range of up to about 180° C. (356° F.). As shown in FIG. 7, a 6.2206 mg sample of sodium hydrogen fluoride was heated to a temperature of about 1,300° C. (2,372° F.). FIG. 7 shows that when sodium hydrogen fluoride contacts the surface of ceramic particles and the temperature is elevated above about 180° C. (356° F.) the sodium hydrogen fluoride surface-modifying agent is thermally unstable and can chemically react with the surfaces of ceramic particles. The preferred treatement temperature is above 350° C. (662° F.).

It is contemplated herein, that different ceramic particle compositions and surface-modifying agents will possess different temperature stability ranges and that the methods of modifying the surface of the ceramic particles can be employed at any temperature wherein the ceramic particle is substantially stable and the surface-modifying agent becomes at least partially thermally unstable. It is further contemplated herein that different temperature ranges may be employed to modify the surface of the ceramic particles by altering the atmospheric pressure surrounding the reaction.

Returning now to FIGS. 1A and 1B, a ceramic particle 10 forms a hydroxylated surface layer 12 when exposed to moisture in the ambient air. This hydroxylated layer, which promotes agglomeration of the ceramic particles when contacted with molten aluminum, is modified by the surface-modifying agent, shown by arrow 14, to reduce the amount of hydroxide present on the surface of the ceramic particle and promote a more uniform distribution in the molten metal. As shown by the first particle of FIG. 1, a metal oxide/hydroxide carbonate ceramic particle has a hydroxylated layer 12 that limits dispersion of the ceramic particles when contacted with a molten metal. By reacting the surface of the ceramic particle with a surface-modifying agent, the hydroxylated surface layer 12 of the ceramic particle is modified to form a dispersion-enhancing fluoro, chloro, boro and/or phospho surface layer 16 on the ceramic particle, as shown by FIGS. 1A and 1B. The dispersion-enhancing fluoro, chloro, boro and/or phospho surface layer 16 allows for greater dispersion of the ceramic material and limited agglomeration when the ceramic particles contact a molten alloy.

In one embodiment, the dispersion-enhancing surface layer formed on the ceramic particles covers at least 50% of the surface of the ceramic particles with at least a bonded monolayer. In another embodiment, the dispersion-enhancing layer can have a thickness of about 1 to about 20 monolayers. In another embodiment, the layer can have a thickness greater than 20 monolayers. As used herein, the term “monolayer” means that the surfaces of the ceramic particles are covered by at least one molecule of bonded surface-modifying agent.

The dispersion-enhancing surface layer is preferably thick enough to allow for sufficient wetting of the ceramic particle in the molten metal or alloy, but thin enough such that the ceramic particle retains the ability to produce gas or enhance melt viscosity when introduced into the molten alloy. In one embodiment of the present invention, the dispersion-enhancing surface layer of the ceramic particles is typically from about 1 nm to about 500 nm thick. In another embodiment, the dispersion-enhancing surface layer is from about 10 nm to about 50 nm thick. In another embodiment, the dispersion-enhancing surface layer has a thickness of about one surface-modifying agent molecule.

The morphology of standard “as received” unaltered CaCO₃ ceramic gassing particles before and after contact with a surface-modifying agent, NH₄—HF₂ compound which provides a dispersion enhancing surface layer, remains substantially unchanged. After the surface treatment, the ceramic gassing particle size distribution essentially remains unchanged from the “as received” material.

Also, the morphology of standard “as received” unaltered MgO ceramic viscosity enhancing particles before and after contact with a surface-modifying agent, NH₄—HF₂ compound which provides a dispersion enhancing surface layer, remains substantially unchanged. After the surface treatment, the ceramic viscosity enhancing particle size distribution essentially remains unchanged from the “as received” material.

The surface of the ceramic particles can be contacted with a surface-modifying agent prior to introducing the ceramic particles into a molten metal or alloy. The surface-modifying agent can also be introduced into the molten metal or alloy before the ceramic particles are added. Unlike previous attempts to make the surfaces of ceramic particles wettable in molten metals by mixing the ceramic particles with fluxing agents, which require the use of both fluxing agents and oxide particles, in the surface treatment method of the present invention, only one reagent is required.

Typically, when the contact angle in a liquid aluminum/ceramic oxide system is greater than 100°, the ceramic is non-wetting. In one embodiment of the present invention, for the ceramic particles to become incorporated into a molten alloy melt, and to prevent flocculation, the liquid/ceramic contact angle is less than about 90°. In another embodiment, the liquid/ceramic contact angle is less than about 50°. When a ceramic particle forms a complex with fluorine, the liquid/ceramic contact angle can be less than about 80°. When a ceramic particle forms a complex with chlorine, the liquid/ceramic contact angle can be less than about 70°. When a ceramic particle forms a complex with boron, the liquid/ceramic contact angle can be less than about 80°. Further, when a ceramic particle forms a complex with any combination of surface-modifying agents, the liquid/ceramic contact angle can be from less than about 80° to less than about 60°.

After the surface of the ceramic particle has been contacted with the surface-modifying agent and subjected to an elevated temperature, the ceramic particles having a dispersion-enhancing surface layer may be incorporated into the molten metal or alloy by mixing techniques such as high speed agitation, gas injection, and/or inserting a master alloy composition with the required particles to form a metal-ceramic melt. As used herein, the term “molten metal” means a body of metal, including any corresponding alloys, at least a portion of which is molten, e.g., in the liquid state. Examples of metals suitable for use in the manufacture of foamed metal products of the present invention include aluminum, copper, brass, bronze, magnesium, cobalt, nickel, silver and any alloy corresponding thereof. Examples of suitable aluminum alloys include any of the Aluminum Association (“AA”) registered alloys such as the 1XXX, 2XXX, 3XXX, 4XXX, 5XXX, 6XXX, 7XXX, and 8XXX series alloys as well as any master alloys. Examples of alloys particularly well suited for use with the present invention include 2XXX, 5XXX, 6XXX, and variety of aluminum of scrap streams.

In one embodiment, the metal-ceramic melt comprises from about 0.01 weight percent to about 20 weight percent ceramic particles. In another embodiment, the metal-ceramic melt comprises from about 1 weight percent to about 15 weight percent ceramic particles. The metal phase of the metal-ceramic melt is typically present in amounts of from about 99 weight percent to about 80 weight percent. The metal phase of the metal-ceramic melt can comprise from about 95 weight percent to about 85 weight percent.

In one embodiment of the invention, the metal phase is continuous, i.e. the metal phase forms a skeletal structure around the ceramic phase. In another embodiment, the metal phase may be discontinuous. The ceramic phase is typically discontinuous.

Once the ceramic particles having a dispersion-enhancing surface layer are dispersed into the molten alloy, the metal-ceramic melt is heated for a duration of from about 0.1 to about 2 hours. The molten metal-ceramic melt can be subsequently solidified by any conventional means into sheet, slab, ingot or billet. Porous metal products made by the process of this invention exhibit low density and high rigidity, improved tensile strength, impact resistance, yield strength and sound deadening properties as well as reduced thermal conductivity.

The porous metal products made by the process of this invention can be suitable for use in thin sheet applications due to their improved tensile strength. In one embodiment, the molten metal-ceramic melt is cast into a near net shape. In another embodiment, the molten metal-ceramic melt is cast and solidified and subsequently sheared into a desired shape. In another embodiment, the solidified product, cast having a near net thickness, can be sheared to obtain the desired length and width. In one embodiment, the solidified product is sheared into sheets having dimensions of about 1.2 m (4 feet) by about 2.4 m (8 feet). In another embodiment, the solidified product is sheared into sheets having dimensions of about 1.8 m (6 feet) by about 3 m (10 feet). In another embodiment, the solidified product can be sheared into any desirable size corresponding to standard building material dimensions, such as plywood dimensions. Although the metal-ceramic melt is typically cast having a near net thickness, some subsequent reduction in thickness may be desirable to aid in evening the surface of the product. In another embodiment, the solidified product is a sheet having a thickness of from about 1 mm to about 254 mm. In another embodiment of the present invention, the thin sheet has a thickness of from about 6 mm to about 50 mm.

The porous metal products made by the process of this invention can be suitable for use in architectural applications due to their improved impact resistance and yield strength. The porous metal products made by the process of this invention can also be suitable for use in the flotation industry, the aquatic recreation industry and military applications due to their comparatively light density. In one embodiment of the present invention, the porous metal product made by the process of this invention has a density of less than about 2.7 g/cc. In another embodiment of the present invention, the porous metal product made by the process of this invention has a density of less than about 1.3 g/cc. In yet another embodiment of the present invention, the porous metal product made by the process of this invention has a density of less than about 0.6 g/cc.

### EXAMPLE 1

A porous metal product having improved homogeneity of th,e metal phase and the ceramic phase was produced in accordance with the present invention as follows: A molten aluminum alloy was provided in which ceramic gassing agents were added. The temperature of the molten aluminum alloy was subsequently reduced to increase the melt viscosity. The atmospheric pressure around the melt was reduced to promote gassing within the melt, and the melt was subsequently cooled to form a stable article having a multiplicity of pores.

### EXAMPLE 2

A porous metal product having improved homogeneity of the metal phase and the ceramic phase was produced in accordance with the present invention as follows. A molten aluminum alloy was provided in which ceramic gassing agents and ceramic viscosity enhancing agents were added. The temperature of the molten aluminum alloy was held constant for a duration sufficient to promote gassing of the melt and the melt was subsequently cooled by rapidly decreasing the melt temperature to form a stable article having a multiplicity of pores.

It will be readily appreciated by those skilled in the art that modifications may be made to the invention without departing from the concepts disclosed in the foregoing description. Accordingly, the particular embodiments described in detail herein are illustrative only and are not limiting to the scope of the invention.

What is claimed is:

1. A method of making a porous metal product comprising:
providing ceramic particles having a dispersion-enhancing surface layer;
combining the ceramic particles with molten metal and forming a foamed metal-ceramic melt; and
solidifying the metal-ceramic melt to form a porous metal product.

2. The method according to claim 1, wherein the ceramic particles comprise at least one element selected from the group comprising: alkali metals, alkaline earth metals, transition metals, Al, Si, Ga, Ge, In, Sn and Bi.

3. The method according to claim 1, wherein the ceramic particles are gassing agents that form at least some gas within the melt.

4. The method according to claim 3, wherein the ceramic particles are gassing agents that form at least some gas within the melt and that the particle size distribution of the ceramic particles remains essentially unchanged from the particles as provided.

5. The method according to claim 3, wherein the gassing agents are selected from the group comprising inorganic carbonates, hydrides, fluorides, sulfates, nitrates, nitrites, hydroxides and combinations thereof.

6. The method according to claim 1, wherein the ceramic particles are viscosity-enhancing agents that increase the viscosity of the melt.

7. The method according to claim 6, wherein the ceramic particles are viscosity enhancing agents that increase the viscosity of the melt and that the particle size distribution of the ceramic particles remains essentially unchanged from the particles as provided.

8. The method according to claim 6, wherein the viscosity enhancing agents are selected from the group comprising combinations of metal and oxides, hydroxides, nitrides, borides, chlorides, carbides, sulfides, sulfites, phosphates and combinations thereof.

9. The method according to claim 1, wherein the ceramic particles have an average size of from about 10 nm to about 3 mm.

10. The method according to claim 1, further comprising selecting the ceramic particle size to correspond to a foamed metal pore size.

11. The method according to claim 1, wherein the dispersion-enhancing surface layer comprises a chemical reaction product of at least one fluorine, chlorine, boron or phosphate compound with an initial surface layer of the ceramic particles.

12. The method according to claim 11, wherein the initial surface layer comprises oxygen, oxides and/or hydroxides.

13. The method according to claim 1, wherein the dispersion-enhancing surface layer has a thickness of from about 1 nm to about 500 nm.

14. The method according to claim 1, wherein the dispersion-enhancing surface layer covers at least 50% of the surface of the ceramic particles.

15. The method according to claim 1, wherein the molten metal comprises at least one of aluminum, copper, brass, bronze, magnesium, cobalt, nickel, silver or any corresponding alloys or combinations of alloys thereof.

16. The method according to claim 1, wherein combining the ceramic particles with molten metal comprises high-speed agitation, gas injection, and/or inserting a master alloy composition into the molten metal.

17. The method according to claim 1, wherein the metal-ceramic melt comprises from about 0.01 weight percent to about 20 weight percent ceramic particles.

18. The method according to claim 1, wherein the porous metal product is in the form of a thin sheet.

19. The method according to claim 1, wherein the porous metal product has a density of less than about 2.7 g/cc.

20. The method according to claim 1, wherein the porous metal product has a density of less than about 1.3 g/cc.

21. The method according to claim 1, wherein the porous metal product has a density of less than about 0.6 g/cc.

22. A method of making a ceramic particles having a dispersion-enhancing surface layer, the method comprising:
providing ceramic particles having an initial surface layer having at least some oxygen, oxide and/or hydroxide;
contacting the initial surface layer of the ceramic particles with a surface-modifying agent; and
forming a dispersion-enhancing surface layer on the ceramic particles.

23. The method according to claim 22, further comprising heating the ceramic particles and the surface-modifying agent to an elevated temperature at which the ceramic particle is substantially stable and the surface-modifying agent is thermally unstable.

24. The method according to claim 23, wherein the elevated temperature is at least about 50° C.

25. The method according to claim 23, wherein the elevated temperature is from about 100° C to about 500° C.

26. The method according to claim 23, wherein the surface-modifying agent comprises at least one fluorine, chlorine, boron and/or phosphate containing compound and/or combinations thereof.

27. The method according to claim 23, wherein the dispersion-enhancing surface layer comprises a chemical reaction product of at least one fluorine, chlorine, boron or phosphate compound with the initial surface layer of the ceramic particles.

28. The method according to claim 23, wherein the dispersion-enhancing surface layer has a thickness of from about 1 nm to about 500 nm.

29. The method according to claim 23, wherein the dispersion-enhancing surface layer covers at least 50% of the surface of the ceramic particles.

30. Ceramic particles for use in the manufacture of porous metal products comprising:
a ceramic core; and
a dispersion-enhancing surface layer comprising a chemical reaction product of at least one fluorine, chlorine, boron or phosphate compound with an initial surface layer of the ceramic core.

31. The ceramic particles according to claim 30, wherein the dispersion-enhancing surface layer has a thickness of from about 1 nm to about 500 nm.

32. The ceramic particles according to claim 30, wherein the dispersion-enhancing surface layer covers at least 50% of the surface of the ceramic core.

33. The ceramic particles according to claim 30, wherein the initial surface layer comprises oxygen, oxides and/or hydroxides.

34. The ceramic particles according to claim 30, wherein the ceramic particles comprise at least one element selected from the group comprising: alkali metals, alkaline earth metals, transition metals, Al, Si, Ga, Ge, In, Sn and Bi.

35. The ceramic particles according to claim 30, wherein the ceramic core is selected from the group comprising inorganic carbonates, hydrides, fluorides, sulfates, nitrates, nitrites, hydroxides, combinations of metal and oxides, hydroxides, nitrides, borides, chlorides, carbides, sulfides, sulfites, phosphates and combinations thereof.

36. The ceramic particles according to claim 28, wherein the ceramic core has an average size of from about 10 nm to about 3 mm.

37. A porous metal product comprising:
a porous metal matrix comprising a discontinuous distribution of closed pores; and
a distribution of ceramic particles having a dispersion-enhancing surface layer comprising at least one fluorine, chlorine, boron or phosphate compound dispersed within the metal matrix.

38. The porous metal product of claim 37, wherein the porous metal product has a density of less than about 2.7 g/cc.

39. The porous metal product of claim 37, wherein the porous metal product has a density of less than about 1.3 g/cc.

40. The porous metal product of claim 37, wherein the porous metal product has a density of less than about 0.6 g/cc.

41. The porous metal product of claim 37, wherein the product is in the form of a sheet.
